(19) United States
(12) Patent Application Publication
(10) Pub. No.: US 2009/0075719 A1
(43) Pub. Date: Mar. 19, 2009

(54) APPARATUS AND A METHOD FOR PLAYING A GAME

(76) Inventor: Alexander Gak, Fort Lee, NJ (US)

Correspondence Address: HOWARD & HOWARD ATTORNEYS PLLC, 450 West Fourth Street, Royal Oak, MI, 48067, US

(21) Appl. No.: 12/211,489

(22) Filed: Sep. 16, 2008

Related U.S. Application Data
(60) Provisional application No. 60/972,832, filed on Sep. 17, 2007.

(51) Int. Cl. A63F 13/00; A63F 3/08

(52) U.S. Cl. 463/20; 273/274

(57) ABSTRACT

A game includes a plurality of cells and a plurality of symbols arranged in a grid which defines a payline. The game has a result equal to a random one of the symbols being associated with each of the cells. The game allows a player to associate a first token and/or a second token with the payline. The tokens have associated symbols and are used to establish respective first and second wagers. The game is played and an actual result is determined. A first award is provided to the player as a function of the first wager and a first paytable if the symbol corresponding to the first token appears in each cell of the payline and providing a second award to the player as a function of the second wager and a second paytable if the symbol corresponding to the second token appears in each cell of the payline. The second paytable reflects a greater risk and higher potential payout than the first paytable.

### RELATED APPLICATIONS

The present invention claims priority to U.S. Provisional Patent Application Ser. No. 60/972,832, filed on Sep. 17, 2007 (attorney docket no. 060708.00007), which is hereby incorporated by reference in their entirety.

### FIELD OF THE INVENTION

The present invention relates to a game upon which a player may make a wager and more particularly to a game upon which a player may make different wagers with different risk levels.

### BACKGROUND OF THE INVENTION

Various games already exist in a gaming arena. For example, U.S. Pat. No. 6,896,264 offers a dice game that uses two six-sided dice and with a payout for either a single roll or a wager where a winner is determined two consecutive rolls. U.S. Pat. No. 6,893,019 offers a dice game that uses three six-side dice to determine a winning wagers. The game offers various payout odds for each wager and a winning wager is determined by the sum of the single die, a pair of dice, or all three dice, on a single roll of all three dice.

There are generally two types of gaming experiences offered on a typical casino floor, namely, the table game experience and the slot machine experience. The major difference between the two is the ability to influence the outcome of the game that is present in table games. For those, who are willing to give up that ability and leave it all to chance, the slot games offer such an opportunity. Table games and slot machines can be, therefore, be thought of in terms of active and passive gambling, respectively.

Unfortunately, the current reality is such that whenever one wants to change the style of playing from passive to active, for example, one has to physically move to a different gaming apparatus that offers the desired gaming experience. Furthermore, few of the prior art games ever are successful because they often have complex wagering schemes or are too simple to captivate a player.

The present invention is aimed at one or more of the problems as set forth above.

### SUMMARY OF THE INVENTION

In a first aspect of the present invention, a method for playing a game is provided. The game includes a plurality of cells and a plurality of symbols. The cells are arranged in a grid of r rows and i columns and having at least one defined payline. The game having a result equal to a random one of the symbols being associated with each of the cells. The method including the step of providing a first token corresponding to a first one of the symbols, allowing a player to associate the first token with the payline, providing a second token corresponding to a second one of the symbols, and allowing the player to associate the second token with the payline. The first token has an associated first stake. The second token has an associated second stake. The method also includes the steps of creating a first wager on the payline and creating a second wager on the payline. The first wager has a first wager amount which is a function of the first stake and the second wager has a second wager amount which is a function of the second stake. The game is played and an actual result is determined. The method further includes the steps of responsively providing a first award to the player as a function of the first wager and a first paytable if the first one of the symbols appears in each cell of the payline and providing a second award to the player as a function of the second wager and a second paytable if the second one of the symbols appears in each cell of the payline, the second paytable reflecting a greater risk and higher potential payout than the first paytable.

In a second aspect of the present invention, a gaming apparatus for playing a game using a plurality of symbols is provided. The gaming apparatus includes a display, a player interface, and a game controller. The display displays a plurality of cells arranged in a grid of r rows and c columns and has at least one defined payline. The at least one defined payline has c cells. The game has an actual result equal to a random one of the symbols being associated with each of the cells. The player interface provides a first token corresponding to a first one of the symbols. The first token has an associated first stake. The player interface allows a player to associate the first token with the payline and provides a second token corresponding to a second one of the symbols. The second token has an associated first stake and allows the player to associate the first token with the payline. The game controller is coupled to the display and the player interface for creating a first wager on the payline. The first wager has a first wager amount being a function of the first stake. The game controller creating a second wager on the payline, the second wager having a second wager amount being a function of the second stake, and for playing the game and arriving at the actual result, and for providing a first award to the player as a function of the first wager and a first paytable if the first one of the symbols appears in each cell of the payline and providing a second award to the player as a function of the second wager and a second paytable if the second one of the symbols appears in each cell of the payline, the second paytable reflecting a greater risk and higher potential payout than the first paytable.

In a third of the present invention, a method for playing a game is provided. The game includes a plurality of cells and a plurality of symbols. The cells are arranged in a grid of r rows and c columns and having at least one defined payline. The game has a result equal to a random one of the symbols being associated with each of the cells. The plurality of symbols includes a risk symbol and a high risk symbol. The method includes the steps of providing a risk token corresponding to a risk symbol, allowing a player to associate the risk token with the payline, providing a high risk token corresponding to a high risk symbol, and allowing the player to associate the high risk token with the payline. The risk token has an associated first stake and the high risk token has an associated second stake. The method further includes the steps of creating a first wager on the payline, creating a second wager on the payline, and playing the game and arriving at an actual result. The first wager has a first wager amount which is a function of the first stake and the second wager has a second wager amount which is a function of the second stake. The method further includes the steps of responsively providing a risk award to the player as a function of the first wager and a risk paytable if the risk symbol appears in each cell of the payline and providing a high risk award to the player as a function of the second wager and a high risk paytable if the high risk symbol appears in each cell of the payline. The high risk paytable reflects a greater risk and higher potential payout than the risk paytable.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of a gaming machine for providing a game with an active mode or a passive mode and which may allow the player to wagers having different risk levels;

FIG. 2 is a diagrammatical illustration of three tokens used to designate wagers of different risk levels, according to an embodiment of the present invention;

FIG. 3 is a diagrammatical illustration of a control for allowing a player to modify the stake or value of a token, according to an embodiment of the present invention;

FIG. 4 is a diagrammatical illustration of three bonus symbols, according to an embodiment of the present invention;

FIG. 5 is a diagrammatic illustration of a graphic displaying sample paytables;

FIG. 6 is a diagrammatic illustration of a graphic displaying user controls and statistic fields;

FIG. 7 is a diagrammatic illustration of a graphic displaying a message screen;

FIG. 8 is a flow diagram of a first method for playing a game, according to an embodiment of the present invention;

FIG. 9 is a flow diagram of a second method for playing a game, according to another embodiment of the present invention;

FIG. 10 is a diagrammatic illustration of another screen shot of the game of FIG. 2;

FIG. 11 is a diagrammatic illustration of another screen shot of the game of FIG. 1;

FIG. 12 is a diagrammatic illustration of another screen shot of the game of FIG. 1;

FIG. 13 is a diagrammatic illustration of another screen shot of the game of FIG. 1;

FIG. 14 is a diagrammatic illustration of another screen shot of the game of FIG. 1; and

FIG. 15 is a diagrammatic illustration of another screen shot of the game of FIG. 1.

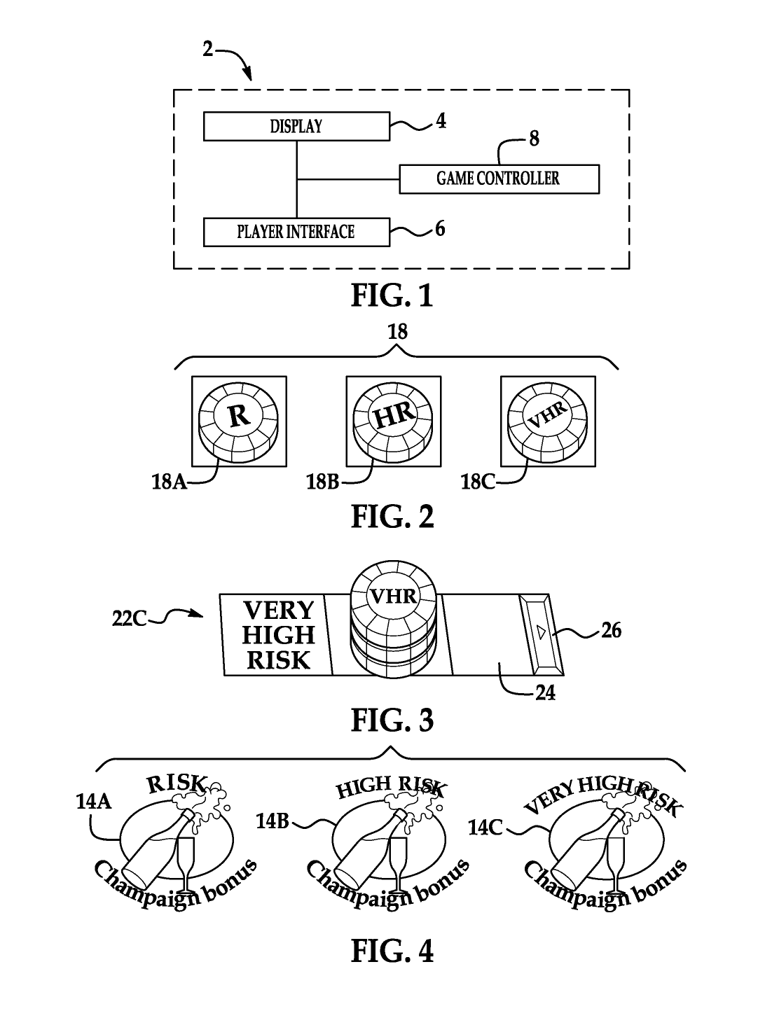

### DETAILED DESCRIPTION OF THE INVENTION

With reference to the drawings, wherein like numerals indicate corresponding parts throughout the several views, and in operation, the present invention provides a gaming apparatus 2 and method for the play of a game. The gaming apparatus 2 may be embodied as a table game, or a console or in a game cabinet, or embodied in a computer software program playable on a computer. The game may be provided in a suitable environment such as a casino, or may be provided in a public location such as a bar or restaurant. The game may also be provided over a network, such as the internet.

For the purposes of illustration and discussion, a computer software embodiment is disclosed and discussed. However, the present invention is not limited to such.

The gaming apparatus 2 includes a display 4, a player interface 6, and a game controller 8. In the computer software embodiment, the gaming apparatus 2 is a computer, such as a personal computer or a PDA. The player interface 6 may include a keyboard and/or mouse and/or touchscreen sensor (not shown) or other suitable input device. The game controller 8 may include the computers microprocessor (not shown).

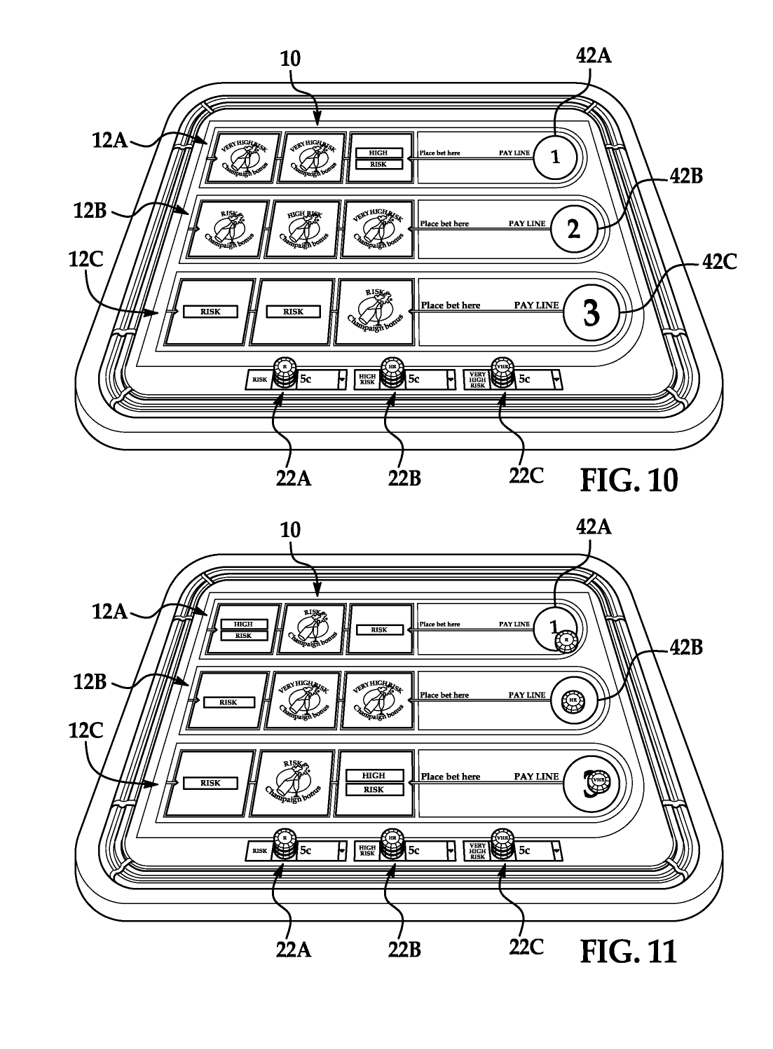

In a first aspect of the present invention, the gaming apparatus 2 allows a player to make a wager and play a game as described below. The game utilizes a plurality of symbols 14. The display 4 is used to display a plurality of cells 10 (see below). The game has an actual result which is equal to a random one of the symbols 14 being associated with each of the cells 10. In one aspect of the present invention, the cells 10 are displayed in a grid having r rows and c columns. As shown in FIGS. 10-15, in the illustrated embodiment, there are 9 cells 10 in a 3×3 grid.

The cells 10 define at least one payline. In the illustrated embodiment, there are three paylines 12A, 12B, 12B. Each payline 12A, 12B, 12B includes a cell 10 in each column and, in the illustrated embodiment, form a horizontal line. However, it should be noted that the present invention is not limited to the number of cells, the size or horizontal paylines.

As described below, the player interface 6 allows the player to make wagers on individual paylines 12A, 12B, 12C. In one aspect of the present invention, the player may make wagers corresponding to different pre-set odds of matching a corresponding winning combination. Generally, the pre-set odds having a higher risk, i.e., a less chance of a winning combination appearing, have a greater potential payout or award.

For example, in the illustrated embodiment, the player may make three types of wagers, referred to as RISK (R) wager, a HIGH RISK (HR) wager, and a VERY HIGH RISK (VHR) wager.

The player interface 6 provides a plurality of tokens 18, which may be in the form of virtual “chips”. Each token or chip 18 corresponds to one of the types of wagers. In the illustrated embodiment, three tokens or chips 18A, 18B, 18C corresponding to the RISK (R) wager, a HIGH RISK (HR) wager, and a VERY HIGH RISK (VHR) wager, respectively. However, it should be noted that the present invention is not limited to three different types of wagers, i.e., two or more different types of wagers may be provided.

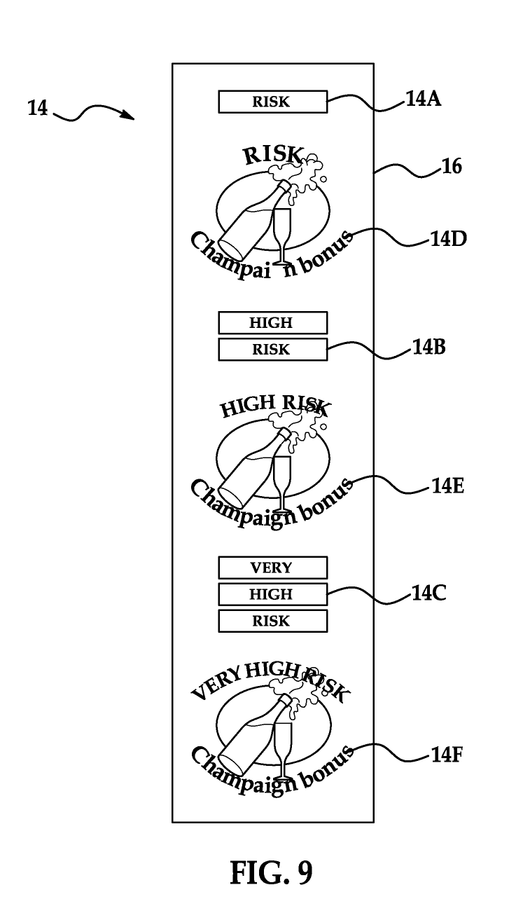

With particular reference to FIG. 9, in one aspect of the present invention, the set of symbols 14 include the symbols corresponding to the wager types, i.e., a RISK symbol 14A, a HIGH RISK symbol 14B, and a VERY HIGH RISK 14C. In addition, the set of symbols 14 include one or more bonus symbols, shown as a RISK CHAMPAGNE BONUS symbol 14D, a HIGH RISK CHAMPAGNE BONUS symbol 14E, and a VERY HIGH RISK CHAMPAGNE BONUS 14F (see below). One or more wild card symbols (not shown) may also be provided.

In other embodiment, the set of symbols 14 may also include non-winning symbols, i.e., symbols which do not make up part of a winning combination or bonus.

The player interface 6 allows the player to associate one of the tokens with one of the paylines 12A, 12B, 12C. Each token or chip 18 has an associated amount or stake. The stake or amount may be expressed in terms of a monetary amount, e.g., $0.05, or a number of credits.

The game controller 8 is coupled to the display 4 and the player interface 6. In response to the player associated one or more of the tokens 18 with one of the cells 10, the game controller 8 creates wager(s). As described below, the player may:
associate one or more of the same tokens 18 with the same payline 12A, 12B, 12C,
associate the same token 18 with more than one payline 12A, 12B, 12C, and,
associate different tokens 18 with the same or multiple paylines 12A, 12B, 12C.

After the player has associated the token(s) 18 with the payline 12A, 12B, 12C, a wager is created or established. A wager is created for each type of wager on each payline and has an associated wager amount. The wager amount for a particular wager is the associated stake multiplied by the number of associated tokens placed on a given payline. For example, if the player associates a single token having a first stake or amount to one of the paylines 12, the wager amount is equal to the first stake or token amount. However, if the player associated the same token to a payline 12 N times, then the wager amount is N×the token amount.

In a more complex example, if the player places 3 RISK tokens 18A on the first payline 12A and 4 HIGH RISK tokens 18B on the first payline 12A, then two wagers are created. Assuming, the stake of the RISK token 18A if $0.05 and the stake of the HIGH RISK token 18B is $0.10, then the wager amount of the first wager is $0.15 (3 times $0.05) and the wager amount of the second wager is $0.40 (4×$0.10). A player's total wager is the sum of all token amounts or stakes of all of the tokens 18 associated with all of the paylines 12.

After the wager is created and the player initiates the game, the game controller 8 plays the game and randomly establishes the actual result. In one embodiment, the actual result may be randomly establishing using the computer program application or may be established using a separate random number generator as is known in the art. The random number generator or computer program application may generate a random number out of a total number of possible outcome numbers to establish the actual outcome. It should be noted that although there may be an equal chance of a particular number, and thus a particular outcome, being generated, the probability associated with the possible outcomes of the outcome generator might not be equal.

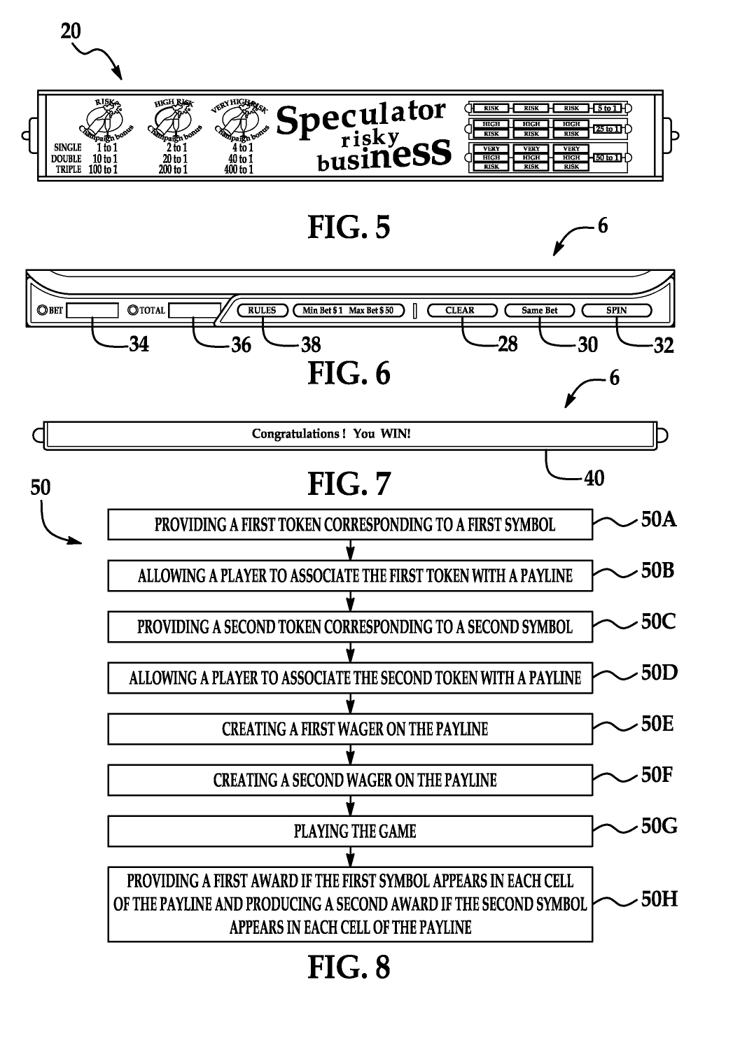

The game control 8 provides an award (in terms of a monetary amount or a number of credits) if the actual results of the cells in a payline on which the player has placed one or more tokens of a particular type is equal to the wager symbol as a function of the wager amount and a predetermined paytable. Exemplary pay tables 20 is shown in FIG. 5.

For example, if the player places 3 RISK tokens 18A on the first payline 12A, assuming that the stake associated with the RISK token 18A is $0.05, then the wager amount is $0.15. After the game has been played, if three RISK symbols 14A appear in each cell of the first payline 12A, then the player will be awarded an award. From the exemplary paytable 20, the RISK wager pays 5 to 1, thus the award will be $0.75.

In one aspect of the present invention, the cells 10 are arranged in a grid. The grid may be rectangular or square. In one embodiment, as shown in FIGS. 2-18, the gaming apparatus 2 includes a 9 cells 23A-23I arranged in a 3×3 grid. However, other sizes, such as a 3×5 grid may be used.

Alternatively, other grid shapes may also be used, such as triangles, diamonds, hexagons, etc. . . . .

In one aspect of the present invention, each cell 10 represents or has an associated reel 22. Each reel 22 has a plurality of reel positions. Each reel position has an associated symbol. It should be noted that in a mechanical reel system, each reel has a set number of reel position which will generally have a fixed symbol. However, in a video slot type implementation, the number of reel positions and/or the symbols of each reel position on each reel may not be fixed or set. Rather, the number of reel positions or the symbol associated with a reel position may vary depending on the odds and paytable for a specific implementation. FIG. 9 illustrates an exemplary reel strip 16 which includes one of each of the symbols 14 and may be used in a mechanical reel implementation.

In another aspect of the present invention, the game controller 8 and the player interface 6 include a respective control 22A, 22B, 22C to allow the player to modify the stake or amount associated with a respective token or chip 18A, 18B, 18C. With particular reference to FIG. 3, each control 22A, 22B, 22C include provides a window 24 for each token 18A, 18B, 18C with the current respective stake or amount. The window 24 includes an arrow 26 which, upon actuation, provides a menu or list of the possible stakes or amount which may be associated with the tokens 18A, 18B, 18C. The player may also utilize the controls 22A, 22B, 22C to place wagers, by grabbing (clicking) and dragging a token 18A, 18B, 18C to a wager area 42A, 42B, 42C corresponding to a respective payline 12A, 12B, 12C.

In still another aspect of the present invention, the game controller 8 allows the player to repeat the same wager without having to create the wager repeatedly.

In one embodiment, as shown in FIG. 6, the player interface 6 may include a clear bet button 28, a same bet button 30, and a spin button 32. Actuation of the clear bet button 26 removes any wagers, i.e., the associated of any tokens 18A, 18B, 18C with the cells 10. Actuation of the same bet button 28 initiates the game and spins the reels using the same bet as the last game. Actuation of the spin button 30 initiates the game using a newly created wager. The player interface 6 also includes a bet window 34 which is used to show the player's total current wager, and a total window 36 which is used to show the player's total remaining credits. After the player hits the same bet button 30 or the spin button 32, the total wager displayed in the bet window 34 is subtracted from the player's total displayed in the total window 36. The player interface 6 may also include a rule buttons 38, actuation of which displays a rules screen (not shown).

With specific reference to FIG. 7, the player interface 6 may also include a message window 40 for display of messages to the player throughout the game.

With specific reference to FIG. 8, a method 50 for playing a game according to one embodiment of the present invention is shown. The game includes a plurality of cells 10 and a plurality of symbols 14. The cells 10 are arranged in a grid of r rows and c columns and having at least one defined payline 12A, 12B, 12C. Each payline 2A, 12B, 12C has c cells. The game has a result equal to a random one of the symbols 14 being associated with each of the cells 10.

In a first step 50A, a first token 18A corresponding to a first one of the symbols 14 is provided. The first token 18A has an associated first stake. As discussed above, in one embodiment, the first stake may be established and/or changed by the player through a respective control 22A, 22B, 22C. In a second step 50B, the player is allowed to associate the first token with one of the paylines 12A, 12B, 12C.

In a third step 50C, a second token 18B corresponding to a second one of the symbols 14 is provided. The second token 18B has an associated second stake which also may be modified by the player. In a fourth step 50C, the player is allowed to associate the second token 18B with the same or a different one of the paylines 12A, 12B, 12C.

In a fifth step 50E, a first wager is created on the payline on which the player has placed the first token 18A. The first wager has a first wager amount which is a function of the first stake. For example, as discussed above, the player may place one or more of the first tokens 18A on one of the paylines 12A, 12B, 12C. The first wager amount is a function of the number of tokens 18A placed on the respective payline 12A, 12B, 12C and the first stake.

In a sixth step 50F, a second wager is created on the payline 12A, 12B, 12C on which the player has placed the second token 18B. The second wager has a second wager amount which is a function of the second stake. For example, as discussed above, the player may place one or more of the second tokens 18B on one of the paylines 12A, 12B, 12C. The second wager amount is a function of the number of second tokens 18B placed on the respective payline 12A, 12B, 12C and the second stake.

In a seventh step 50G, the game is played and an actual result is determined.

In an eighth step 50H, a first award is provided to the player as a function of the first wager and a first paytable if the first one of the symbols 14 appears in each cell of the payline (on which the player has placed one or more of the first tokens 18A) and a second award is provided to the player as a function of the second wager and a second paytable if the second one of the symbols appears in each cell of the payline (on which the player has placed one or more of the first tokens 18A). In one aspect of the present invention, if the player places one or more tokens 18 of different types on the same paylines, then only one of the wager types can result in an award to the player.

In one aspect of the present invention, the second paytable reflects a greater risk and higher potential payout or award than the first paytable. With particular reference to FIG. 5, for example, the RISK, HIGH RISK, and VERY HIGH RISK have payout ratios of 5 to 1; 25 to 1; and 50 to 1, respectively.

In another aspect of the present invention, the game provides the player the opportunity to achieve risk bonus awards. For example, the game 2 may include a bonus award corresponding to each wager type. In the illustrated embodiment, the game 2 provide three potential bonus award: a RISK CHAMPAGNE bonus, a HIGH RISK CHAMPAGNE bonus, and a VERY HIGH RISK CHAMPAGNE bonus, which correspond to the RISK CHAMPAGNE bonus, a HIGH RISK CHAMPAGNE bonus, and a VERY HIGH RISK CHAMPAGNE bonus symbols 14D, 14E, 14F.

In one embodiment, the game controller 8 pays a bonus award when the corresponding bonus award symbol 14D, 14E, 14F appears on a payline 12A, 12B, 12C on which the player has placed the corresponding token 18A, 18B, 18C. The bonus payout or award is a function of the wager amount, i.e., the amount the player has awarded at that risk level on that payline and a corresponding pay table.

With particular reference to FIG. 5, the amount of the bonus award may also be dependent upon the number of symbols 14D, 14E, 14F which appear on the payline. For example, in the illustrated embodiment, an exemplary bonus award paytable may be as follows:

| | Risk Champagne | High Risk Champagne | Very High Risk |
|---|---|---|---|
| | Bonus | Bonus | Champagne Bonus |
| Single | 1 to 1 | 2 to 1 | 4 to 1 |
| Double | 10 to 1 | 20 to 1 | 40 to 1 |
| Triple | 100 to 1 | 200 to 1 | 400 to 1 |

With respect to FIG. 10-15, screen shots of an exemplary game 10 are shown. The game concept “Risky Business” is for discussion purposes only. The specific symbols used are for illustration purposes only. The game 10 includes a display 20 with a plurality of rotating reels. In the illustrated embodiment, the rotating reels are displayed in a grid of cells 10.

A 3×3 grid is disclosed, although, a grid of different dimensions, such as, but not limited to, 3×5 or 4×5 or 5×4 may be used. The grid includes nine cells 23A-23I. Each rotating reel has a plurality of positions having a symbol from a symbol set. For example, the symbol set from the “Risky Business” game may include, but is not limited to a RISK symbol 14A, a HIGH RISK symbol 14B, a VERY HIGH RISK symbol 14C, a RISK CHAMPAGNE BONUS symbol 14D, a HIGH RISK CHAMPAGNE BONUS symbol 14E, and a VERY HIGH RISK CHAMPAGNE BONUS symbol 14F. More or alternative symbols may also be used. Other symbol sets, consistent with a particular game theme or concept may also be used.

A player plays the game by placing one or more wagers and starting the game. When the game is begun, the reels spin and then stop. After the reels stop, the player may be paid a payout as a function of the wager(s) and the symbols or combinations of symbols which are displayed (see below).

In one embodiment, each reel has a predetermined number of positions with an associated, predetermined symbol from the symbol set. Each reel may be a mechanical reel controlled by a controller or computer or may be a virtual reel.

In another embodiment, the reels are virtual reels. Each reel has a number of positions, which may be predetermined or may be variable. The number of positions on each reel may also vary between reels. However, the symbol associated with each position is not set. In other words, the outcome of each reel, i.e., the symbol shown in the grid when the reel stops spinning, is randomly chosen. The reels may be animated to give the appearance that the reels are spinning. Choosing random outcomes to achieve predetermined payout odds is well known in the art and therefore not further discussed.

In one aspect of the present invention, the game 10 provides two modes: an active mode and a passive mode. In the active mode, the player actively places wager(s) on the grid in an attempt to influence the outcome of the game. In the passive mode, once the player has created at least one wager, the player may continue to play the same wager(s) by simply selecting the “same bet” option.

In the passive mode, the player may create a desired wager or set of wagers and continuously replay the same wager(s). Alternatively, the game may provide a set or sets of predetermined wager(s). The player need only select the set of desired wagers to play the game.

The display 20 includes a plurality of wager areas 42A, 42B, 42C; one wager area 42A, 42B, 42C corresponding to each payline 12A, 12B, 12C. The player deposits chips or tokens 18A, 18B, 18C into a respective wager area 42A, 42B, 42C to make a wager. To place a wager of a particular type or risk level, the player drags a token 18A, 18B, 18C of the desired type onto the respective wager area 42A, 42B, 42C of the payline 12A, 12B, 12C on which they desire to make a wager. The player may change the value of a chip for each wager type using the respective control 22A, 22B, 22C. It should also be noted that the game 2 may provide different chips for each wager type, each have a different value. The value of these chips may also be modified by the player.

After the makes one or more wager, the player starts the game by hitting the same bet button 30 or the spin button 32. The reels are then spun. Once the reels stop, the player is paid out if all the cells 10 of a payline 12A, 12B, 12C, on which the player has placed a token 18A, 18B, 18C, contain the symbol 14A, 14B, 14C corresponding to the token 18A, 18B, 18C or one or more of the cells 10 of a payline 12A, 12B, 12C, on which the player has placed a token 18A, 18B, 18C, contain the bonus symbol 14D, 14E, 14F corresponding to the token 18A, 18B, 18C.

With particular reference to FIG. 11, the player has placed a RISK token 18A on the first wager area 42A (corresponding to the first payline 12A), a HIGH RISK token 18B on the second wager area 42B (corresponding to the second payline 12B), and a VERY HIGH RISK token 18C on the third wager area 42C (corresponding to the third payline 12C). The first, second, and third stakes are set at $0.05 as shown. Thus, the first, second and third wager amounts are $0.05 and the total wager amount is $0.15.

With particular reference to FIG. 12, the results of the game shown in FIG. 11 are shown. As shown, no payline includes three of the same symbols 14 which correspond to the token 18A, 18B, 18C placed in the corresponding wager area 42A, 42B, 42C. However, the first payline 12A contains a RISK CHAMPAGNE BONUS symbol 14D. Since the player placed a RISK token 18A on the first wager area 42, the player is awarded a RISK BONUS as a function of the amount wagered and the corresponding RISK BONUS paytable. In the illustrated embodiment, the RISK BONUS pays 5 to 1, thus the bonus awarded to the player is 5×$0.05 or $0.25.

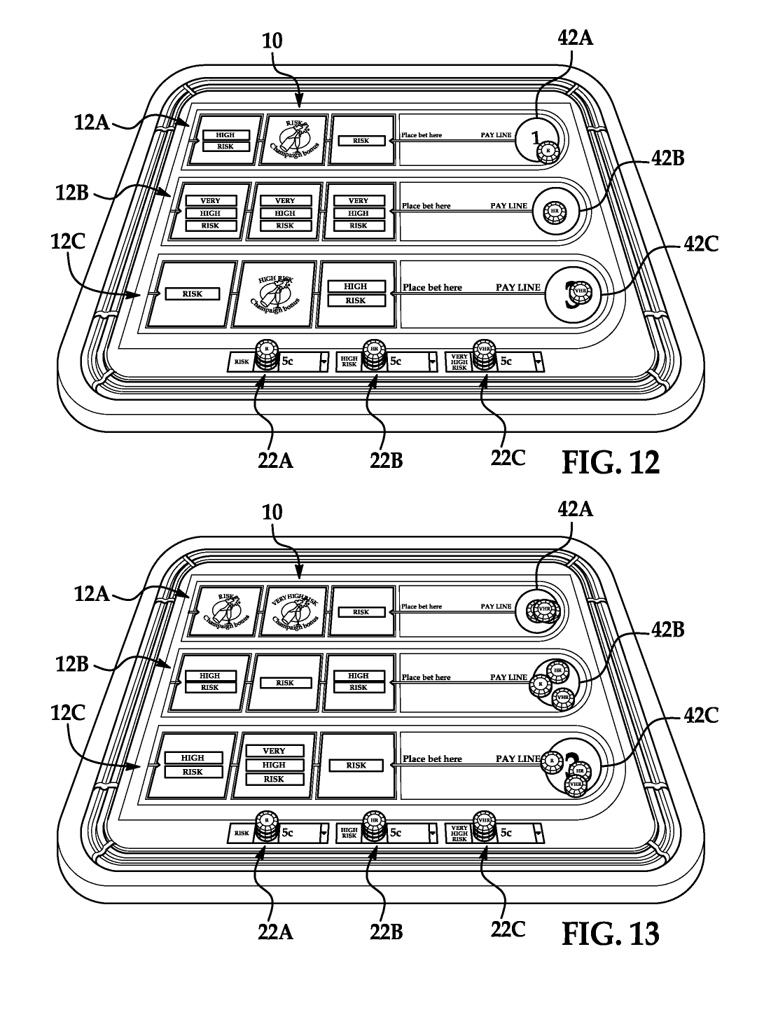

With reference to FIG. 13, the player has placed one of each type of token 18A, 18B, 18C corresponding to each wager type on each payline 12A, 12B, 12C. Since each token 18A, 18B, 18C has a stake equal to $0.05, the total wager is $0.45.

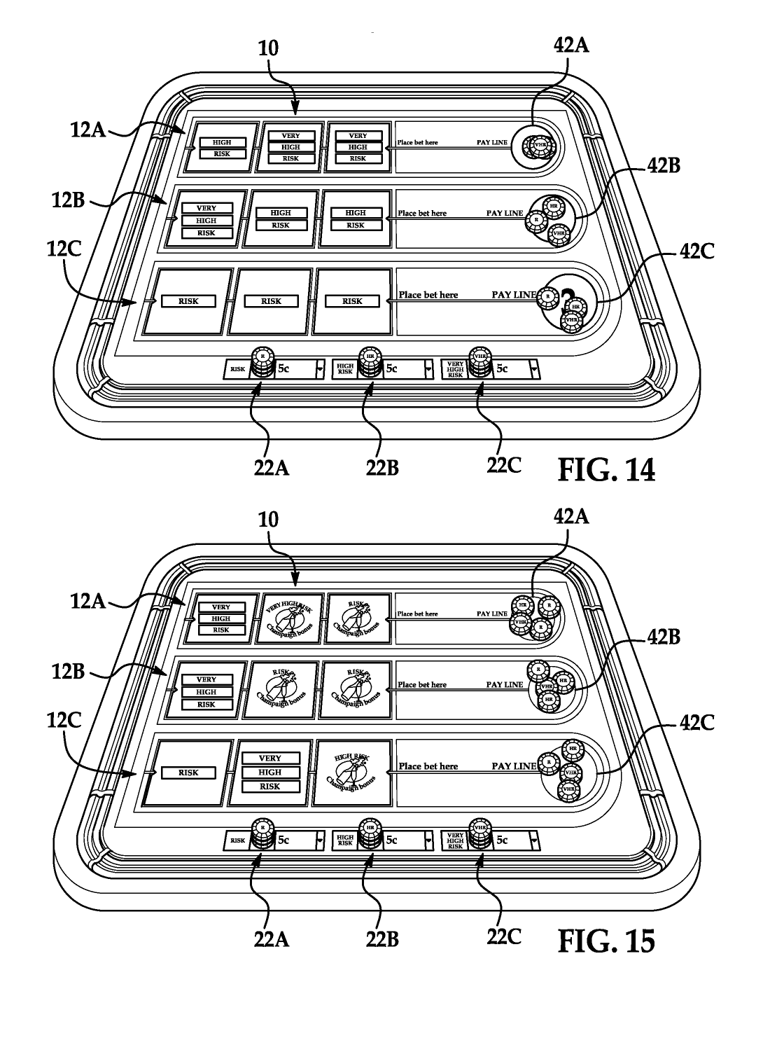

With particular reference to FIG. 14, the results of the game shown in FIG. 13 are shown. As shown, neither the first nor the second paylines 12A, 12B include three of the same symbols 14A, 14B, 14C or contain one of the bonus symbols 14D, 14E, 14F. Therefore, the player is not award any reward based on the first and second paylines 12A, 12B. However, the third payline 12C contain three RISK symbols 14A. Therefore, the player is awarded an award or payout based on the wager of the RISK type made on the third payline 12C and the RISK paytable. In the illustrated embodiment, a RISK wager has a payout of 25 to 1 (see FIG. 5). Thus, the payout is $1.25 (25×$0.05).

With specific reference to FIG. 15, the player has placed:
2 RISK symbols 14A, 1 HIGH RISK symbol 14B, and 1 VERY HIGH RISK SYMBOL 14C on the first payline 12A;
1 RISK symbol 14A, 2 HIGH RISK symbols 14B, and 1 VERY HIGH RISK SYMBOL 14C on the second payline 12B; and,
1 RISK symbol 14A, 1 HIGH RISK symbol 14B, and 2 VERY HIGH RISK SYMBOLS 14C on the third payline 12C.

Since, as shown, the stakes for each type of wager is set at $0.05, the player's total wager is $0.60.

Additionally, once one or more wagers are placed, the player may passively place the same wagers in multiple, continuous games by selecting the same bet button 30.

Obviously, many modifications and variations of the present invention are possible in light of the above teachings. The invention may be practiced otherwise than as specifically described within the scope of the appended claims.

What is claimed is:

1. A method for playing a game, the game including a plurality of cells and a plurality of symbols, the cells being arranged in a grid of r rows and c columns and having at least one defined payline, the at least one defined payline having c cells, the game having a result equal to a random one of the symbols being associated with each of the cells, comprising:
providing a first token corresponding to a first one of the symbols, the first token having an associated first stake;
allowing a player to associate the first token with the payline;
providing a second token corresponding to a second one of the symbols, the second token having an associated second stake;
allowing the player to associate the second token with the payline;
creating a first wager on the payline, the first wager having a first wager amount being a function of the first stake;
creating a second wager on the payline, the second wager having a second wager amount being a function of the second stake;
playing the game and arriving at an actual result; and,
responsively providing a first award to the player as a function of the first wager and a first paytable if the first one of the symbols appears in each cell of the payline and providing a second award to the player as a function of the second wager and a second paytable if the second one of the symbols appears in each cell of the payline, the second paytable reflecting a greater risk and higher potential payout than the first paytable.

2. A method, as set forth in claim 1, wherein each cell represents a reel having a plurality of reel positions, each reel position having an associated one of the symbols.

3. A method, as set forth in claim 1, wherein the game is implemented as a video or mechanical slot reel game.

4. A method, as set forth in claim 1, wherein the game is implemented in a computer program playable on a computer.

5. A method, as set forth in claim 1, including the step of providing a second payline.

6. A method, as set forth in claim 5, including the steps of:
allowing the player to associate another first token with the second payline;
allowing the player to associate another second token with the second payline;
creating another first wager on the second payline, the another first wager having another first wager amount being a function of the first stake;
creating another second wager on the second payline, the second wager having another second wager amount being a function of the second stake; and,
responsively providing another first award to the player as a function of the another first wager and the first paytable if the first one of the symbols appears in each cell of the second payline and providing another second award to the player as a function of the another second wager and the second paytable if the second one of the symbols appears in each cell of the second payline.

7. A method, as set forth in claim 1, including the step of allowing the player to associate the first token and the second token with the payline multiple times, the first wager amount being a function of the first stake and the number of times the first token is associated with the payline, the second wager amount being a function of the second stake and the number of times the second token is associated with the payline.

8. A method, as set forth in claim 1, including the step of allowing the player to modify the first stake and the second stake.

9. A method, as set forth in claim 1, including the step of allowing the player to play the game again using the same first and second wagers.

10. A method, as set forth in claim 1, including the step of providing a first risk bonus award to the player as a function of the first wager if a first risk bonus symbol corresponding to the first one of the symbols appears on the payline.

11. A method, as set forth in claim 10, including the step of providing a second risk bonus award to the player as a function of the second wager if a second risk bonus symbol corresponding to the second one of the symbols appears on the payline.

12. A gaming apparatus for playing a game using a plurality of symbols, comprising:
a display for displaying a plurality of cells arranged in a grid of r rows and c columns and having at least one defined payline, the at least one defined payline having c cells, the game having an actual result equal to a random one of the symbols being associated with each of the cells;
a player interface for providing a first token corresponding to a first one of the symbols, the first token having an associated first stake, and allowing a player to associate the first token with the payline and for providing a second token corresponding to a second one of the symbols, the second token having an associated first stake, and allowing the player to associate the first token with the payline; and,
a game controller coupled to the display and player interface for creating a first wager on the payline, the first wager having a first wager amount being a function of the first stake, for creating a second wager on the payline, the second wager having a second wager amount being a function of the second stake, and for playing the game and arriving at the actual result, and for providing a first award to the player as a function of the first wager and a first paytable if the first one of the symbols appears in each cell of the payline and providing a second award to the player as a function of the second wager and a second paytable if the second one of the symbols appears in each cell of the payline, the second paytable reflecting a greater risk and higher potential payout than the first paytable.

13. A gaming apparatus, as set forth in claim 12, wherein each cell represents a reel having a plurality of reel positions, each reel position having an associated one of the symbols.

14. A gaming apparatus, as set forth in claim 12, wherein the game is implemented as a video or mechanical slot reel game.

15. A gaming apparatus, as set forth in claim 12, wherein the game is implemented in a computer program playable on a computer.

16. A gaming apparatus, as set forth in claim 12, the plurality of cells having a second payline.

17. A gaming apparatus, as set forth in claim 16, the player interface for allowing the player to associate another first token with the second payline and for allowing the player to associate another second token with the second payline, the controller for creating another first wager on the second payline, the another first wager having another first wager amount being a function of the first stake, for creating another second wager on the second payline, the second wager having another second wager amount being a function of the second stake, and for responsively providing another first award to the player as a function of the another first wager and the first paytable if the first one of the symbols appears in each cell of the second payline and providing another second award to the player as a function of the another second wager and the second paytable if the second one of the symbols appears in each cell of the second payline

18. A gaming apparatus, as set forth in claim 12, the game controller for allowing the player to associate the first token and the second token with the payline multiple times, the first wager amount being a function of the first stake and the number of times the first token is associated with the payline, the second wager amount being a function of the second stake and the number of times the second token is associated with the payline.

19. A gaming apparatus, as set forth in claim 12, the game controller for allowing the player to modify the first stake and the second stake.

20. A gaming apparatus, as set forth in claim 12, the game controller for allowing the player to play the game again using the same first and second wagers.

21. A gaming apparatus, as set forth in claim 12, the game controller for providing a first risk bonus award to the player as a function of the first wager if a first risk bonus symbol corresponding to the first one of the symbols appears on the payline.

22. A gaming apparatus, as set forth in claim 12, the game controller for providing a second risk bonus award to the player as a function of the second wager if a second risk bonus symbol corresponding to the second one of the symbols appears on the payline.

23. A method for playing a game, the game including a plurality of cells and a plurality of symbols, the cells being arranged in a grid of r rows and c columns and having at least one defined payline, the at least one defined payline having c cells, the game having a result equal to a random one of the symbols being associated with each of the cells, the plurality of symbols include a risk symbol, a high risk symbol and a very high risk symbol, comprising:
providing a risk token corresponding to a risk symbol, the risk token having an associated first stake;
allowing a player to associate the risk token with the payline;
providing a high risk token corresponding to a high risk symbol, the high risk token having an associated second stake;
allowing the player to associate the high risk token with the payline;
creating a first wager on the payline, the first wager having a first wager amount being a function of the first stake;
creating a second wager on the payline, the second wager having a second wager amount being a function of the second stake;
playing the game and arriving at an actual result; and,
responsively providing a risk award to the player as a function of the first wager and a risk paytable if the risk symbol appears in each cell of the payline and providing a high risk award to the player as a function of the second wager and a high risk paytable if the high risk symbol appears in each cell of the payline, the high risk paytable reflecting a greater risk and higher potential payout than the risk paytable.

24. A method, as set forth in claim 23, including the steps of:
providing a very high risk token corresponding to a very high risk symbol, the very high risk token having an associated third stake;
allowing the player to associate the very high risk token with the payline;
creating a third wager on the payline, the third wager having a third wager amount being a function of the third stake; and,
responsively providing a very high risk award to the player as a function of the third wager and a very high risk paytable if the very high risk symbol appears in each cell of the payline and providing a very high risk award to the player as a function of the third wager and a very high risk paytable if the very high risk symbol appears in each cell of the payline.
